(19) United States
(12) Patent Application Publication
(10) Pub. No.: US 2025/0198758 A1
(43) Pub. Date: Jun. 19, 2025

(54) Hyperfine Enhanced Quantum Spin Gyroscope

(71) Applicant: Massachusetts Institute of Technology, Cambridge, MA (US)

(72) Inventors: Paola Cappellaro, Cambridge, MA (US); Guoqing Wang, Cambridge, MA (US); Minh-Thi Nguyen, Cambridge, MA (US)

(21) Appl. No.: 18/982,242

(22) Filed: Dec. 16, 2024

Related U.S. Application Data
(60) Provisional application No. 63/611,149, filed on Dec. 16, 2023.

(51) Int. Cl. G01C 19/60

(52) U.S. Cl. CPC G01C 19/60

(57) ABSTRACT

Solid-state platforms based on electro-nuclear spin systems are attractive candidates for rotation sensing due to their excellent sensitivity, stability, and compact size, compatible with industrial applications. Conventional spin-based gyroscopes measure the accumulated phase of a nuclear spin superposition state to extract the rotation rate and thus suffer from spin dephasing. A gyroscope protocol based on a two-spin system that includes a spin intrinsically tied to the host material, while the other spin is isolated. The rotation rate is then extracted by measuring the relative rotation angle between the two spins starting from their population states, robust against spin dephasing. In particular, the relative rotation rate between the two spins can be enhanced by their hyperfine coupling by more than an order of magnitude, further boosting the achievable sensitivity.

### RELATED APPLICATION

This application claims the benefit of U.S. Provisional Application No. 63/611,149, filed on Dec. 16, 2023. The entire teachings of the above application are incorporated herein by reference.

### GOVERNMENT SUPPORT

This invention was made with government support under grant number PHY-1734011 awarded by the National Science Foundation, and D18AC00024 awarded by the Defense Advanced Research Projects Agency. The government has certain rights in the invention.

### BACKGROUND

Systems and methods for inertial sensing have broad applications, from tests of fundamental physics such as geometric phases and general relativity, to industrial applications such as navigation in the absence of global positioning system (GPS). In recent years, sensing technologies based on quantum systems have demonstrated promising performances in sensitivity, resolution, stability, and other parameters compared with their classical mechanical or electrical counterparts. Among these quantum systems, nuclear spins in solid-state platforms, in particular nitrogen-vacancy (NV) centers in diamond, have emerged as attractive candidates due to their long coherence times, ambient operation conditions, small size, and fabrication capabilities. There is a need for an improved electro-nuclear spin system-based gyroscope and protocol that provides increased inertial sensing sensitivity that enables precise measurement of slow rotations and exploration of fundamental physics.

### SUMMARY

Solid-state platforms based on electro-nuclear spin systems are attractive candidates for rotation sensing due to their excellent sensitivity, stability, compact size, and compatibility with industrial applications. Conventional prior art electro-nuclear spin-based (or “spin-based') gyroscopes measure the accumulated phase of a nuclear spin superposition state to extract rotation rate and thus suffer from spin dephasing. Embodiments of the present invention provide a gyroscope and protocol based on a two-spin system that includes a spin intrinsically tied to the host material, while the other spin is isolated. The rotation rate is then extracted by measuring the relative rotation angle between the two spins starting from their population states, which is robust against spin dephasing. The relative rotation rate between the two spins can be enhanced by their hyperfine coupling by more than an order of magnitude, boosting the achievable gyroscope sensitivity. The ultimate sensitivity of a spin-based gyroscope is limited by the lifetime of the two-spin system and embodiments of the present invention are compatible with a broad dynamic range, even in the presence of magnetic noises or control errors due to initialization and qubit manipulations. Embodiments enable precise measurement of slow rotations and exploration of fundamental physics.

A gyroscope comprising a diamond structure with a nitrogen-vacancy (NV), the nitrogen-vacancy (NV) containing a nitrogen atom, wherein the nitrogen-vacancy (NV) has an electronic spin along a first axis ( [symbol] _{NV}) and the nitrogen atom has a nuclear spin along a second axis and the first axis ( [symbol] _{NV}) is correlated with an orientation of the diamond structure and the second axis is decoupled from the orientation of the diamond structure. The rotation rate of the orientation of the diamond structure (Ω) can be determined based on a projection of the nuclear spin onto the first axis.

The gyroscope may further comprise a photodetector configured to detect a fluorescence signal produced by the nitrogen-vacancy (NV) interacting with a laser, the detected fluorescence signal correlated with a state of the electronic spin along the first axis ( [symbol] _{NV}).

The gyroscope may further comprise a CNOT gate configured to map the state of the electronic spin along the first axis ( [symbol] _{NV}) with a state of the nuclear spin to enable determining the projection of the nuclear spin onto the first axis ( [symbol] _{NV}) based upon the state of the electronic spin along the first axis ( [symbol] _{NV}).

The nitrogen atom can be a ¹⁵N atom. The rotation rate of the orientation of the diamond structure may be about a third axis (ŷ) distinct from the first axis ( [symbol] _{NV}). The electronic spin can be quantized along the first axis ( [symbol] _{NV}) and the first axis can adiabatically follow the orientation of the diamond structure.

The gyroscope may further comprise a source configured to apply an external magnetic field to the diamond structure, the applied external magnetic field causing the second axis to become correlated with a direction of the applied external magnetic field (B). In such embodiments, the rotation rate of the orientation of the diamond structure (Ω) can be significantly less than a Larmor frequency of the nuclear spin.

Additionally, the hyperfine coupling between the electronic spin and the nuclear spin may enhance the rotation of the nuclear spin with respect to the first axis ( [symbol] _{NV}). The applied magnetic field may have a magnitude configured to approximate the GSLAC (ground-state level avoided crossing) condition (γₑB˜D) and maximize the enhancement of an angular difference between the first axis ( [symbol] _{NV}) and the second axis.

A method of determining rotation rate, the method comprising rotating, at a rotation rate, a diamond structure with a nitrogen-vacancy (NV), the nitrogen-vacancy (NV) containing a nitrogen atom wherein the nitrogen-vacancy (NV) has an electronic spin along a first axis (z\tilde{ }NV) and the nitrogen atom has a nuclear spin along a second axis, and the first axis (z\tilde{ }NV) is correlated with an orientation of the diamond structure and the second axis is decoupled from the orientation of the diamond structure. The method also includes determining the rotation rate based on a projection of the nuclear spin onto the first axis.

The method may also include detecting a fluorescence signal produced by the nitrogen-vacancy (NV) interacting with a laser, the detected fluorescence signal correlated with a state of the electronic spin along the first axis ( [symbol] _{NV}).

The method can also include mapping the state of the electronic spin along the first axis ( [symbol] _{NV}) with a state of the nuclear spin to enable determining the projection of the nuclear spin onto the first axis ( [symbol] _{NV}) based upon the state of the electronic spin along the first axis ( [symbol] _{NV}).

In some embodiments, the method further includes applying an external magnetic field to the diamond structure, the applied external magnetic field causing the second axis to become correlated with a direction of the applied external magnetic field (B).

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a schematic view of a gyroscope based on a coupled electro-nuclear spin system according to an example embodiment.

FIG. 1B is a schematic illustration showing the behavior of the nuclear and electronic spins of the system shown in FIG. 1A under a hyperfine enhanced regime,

FIG. 1C is a schematic illustration showing the behavior of the nuclear and electronic spins of the system shown in FIG. 1A under an inertial regime.

FIG. 2A is a graph showing the results of a simulation of the gyroscope protocol of the system shown in FIG. 1A under a hyperfine enhanced regime and under an inertial regime.

FIG. 2B is a schematic illustration showing NV axis rotation (\hat{z}_{NV}), nuclear spin evolution, and nuclear spin eigenstate for the simulated simulation of the gyroscope protocol of the system shown in FIG. 1A under a hyperfine enhanced regime and under an inertial regime.

FIG. 3A is a graph of a coherence analysis for a gyroscope signal under electron spin T1 relaxation in a hyperfine-enhanced regime according to an example embodiment.

FIG. 3B is a graph of a coherence analysis for a gyroscope signal under electron spin T1 relaxation in an inertial regime according to an example embodiment.

FIG. 3C is a graph of the simulated decay time of the transverse evolution of the nuclear spin as a function of magnetic noise strength according to an example embodiment.

FIG. 4A is a graph of the simulated and theoretical rotation enhancement factor of the nuclear spin as a function of applied magnetic field according to an example embodiment.

FIG. 4B is graph of a comparison of the ideal sensitivity of gyroscope protocols under typical conditions, including an example embodiment.

FIG. 4C is a set of heat maps showing sensitivity improvements, provided by example embodiments using hyperfine-enhanced gyroscope protocols, over prior art nuclear Ramsey protocols taking into account the fidelity of normal and adaptive quantum controls.

FIG. 5A is a graph of the predicted enhancement factor, |α₀|, and frequency shift, ⊕′₀/γₙBₓ, for a system rotation θ=π/20 as a function of external magnetic field B of a gyroscope according to an example embodiment.

FIG. 5B is a graphed comparison of simulated and theoretical values of signals produced by a gyroscope exposed to an external magnetic field according to an example embodiment.

FIG. 6 is a timeline of initialization, evolution (rotation), and readout of a gyroscope displaying the utilized laser, microwave, and radiofrequency pulses according to an example embodiment.

FIG. 7A is a set of graphs that map the electronic spin and nuclear spin transition frequencies (σ) as a function of magnetic field misalignment θ at different magnetic field strengths.

FIG. 7B is a set of graphs showing the evolution dynamics of the nuclear spin under normal and adaptive Rabi drives and a magnetic field of B=800 G.

FIG. 8 is a graph of the eigenstate deviation [symbol] (t) of example embodiments as a function of the rotation angle (at a fixed rotation rate (2π)0.1 kHz), for various values of magnetic field strength.

### DETAILED DESCRIPTION

A description of example embodiments follows.

An inertial measurement requires the system to evolve (e.g. rotate) relative to an inertial reference frame (also referred to herein as inertial frame, or lab frame). As used herein “evolve” and “evolution” means change or rotation such as the rotation of a system, the rotation or state change of electronic spin or nuclear spin, and the like. Rotation can be measured by comparing the system's rotation or position to the inertial reference frame or representative thereof. Existing gyroscopes that utilize a nitrogen-vacancy structure (NV) are mostly based on the nuclear spin of a ¹⁴N (I=1) atom contained within system that includes a nitrogen-vacancy (NV) center in a diamond. The nuclear quadrupole term of the contained atom quantizes the system's nuclear spin along the direction of the crystal structure forming the NV, defined as orientation or axis \hat{z}_{NV}. This quantization constrains the nuclear spin to detect longitudinal rotations about \hat{z}_{NV} which correlates to the orientation or rotation of the system. The system's rotation rate can be extracted from the accumulated dynamic phase using a Ramsey sequence and other known techniques in the art.

In contrast to ¹⁴N atoms used in prior art systems, the nuclear spin of the ¹⁵N atom, used in example embodiments, is a

$$spin - \frac{1}{2}$$

without a quadrupole term and thus is effectively uncoupled from the \hat{z}_{NV} axis and its rotation. However, the electronic spin (also referred to as the NV spin) of the system still remains correlated with the \hat{z}_{NV} axis and its rotation. While the hyperfine interaction between the nuclear spin and the electronic spin can still effectively apply a magnetic large field that constrains the quantization of the nuclear spin along \hat{z}_{NV}, such a field vanishes for electronic spin state mₛ=0. Thus, embodiments allow for the nuclear spin to be isolated from the diamond crystal orientation (correlated with \hat{z}_{NV}) and makes the system an ideal platform for inertial sensing. Moreover, the nuclear spin of ¹⁵N atoms used in example embodiments has only two energy levels, making it easier to polarize, control, and read out signals correlated with the nuclear spin.

Despite these benefits, the use of ¹⁵N atoms in NV gyroscopes remains less explored and prior art inertial sensing protocols, confined to the conventional Ramsey methods, are still limited by the nuclear spin dephasing time T₂ₙ^{*}, which is degraded by the presence of transverse field inhomogeneities. Embodiments of the present invention address this deficiency in the prior art and provide a gyroscope protocol based on the ¹⁵N nuclear spin of atom(s) in diamond NV center(s). Example embodiments may utilize any desired number of NV centers containing an atom to create a dual nuclear spin and electronic spin system for inertial sensing. Embodiments, instead of using a superposition state of the nuclear spin to measure longitudinal rotations about \hat{z}_{NV}, use the population state of the nuclear spin to measure rotations along a transverse direction, leading to improved robustness against spin dephasing.

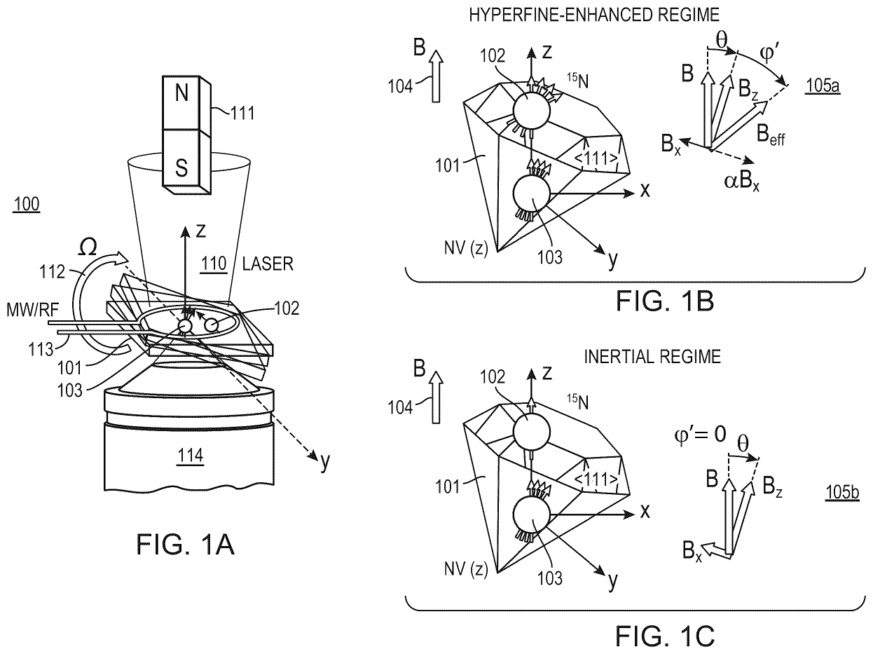

FIG. 1A is a schematic view of a gyroscope 100 based on a coupled electro-nuclear spin system 101 according to an example embodiment. Embodiments include a gyroscope 100 based on an electro-nuclear spin system 101 hosted by point defects in solid-state platforms. System 101 (also referred to herein as “a diamond”) comprises a diamond with a crystal structure that creates at least one NV center having an electronic spin 103 and containing an atom having a nuclear spin 102, for example ¹⁵N atoms. Representations of the nuclear spin 102 and the electronic spin 103 along with their quantized directions are shown in FIGS. 1A-C. The electro-nuclear spin system 101 is exposed to a magnetic field (104 in FIGS. 1B and 1C) generated by magnet 111. Laser 110, microwave/radiofrequency source 113, and detector 114 are used to detect the relative rotations of nuclear spin 102 and the electronic spin 103 and to provide control or calibration signals. Detector 114 may be a lens, photodetector, or other instrument capable of detecting the fluorescence created by system 101 and laser 110. In the example shown in FIG. 1A, the electro-nuclear spin system 101 experiences a rotation rate 112 of Ω along the y axis.

The following disclosure details NV center(s) (providing electronic spin 103) in diamond containing enriched ¹⁵N isotope(s) (providing nuclear spin 102) to illustrate the novel gyroscope protocol. However, one of skill in the art would understand that other sources of electronic spin and nuclear spin can be used to create electro-nuclear spin system 101 and gyroscope 100. Specifically, the NV center of the system 101 has an electronic spin 103 equaling −1 and a nuclear spin

$$102 equaling - \frac{1}{2} .$$

Due to its isolation from the environment, the nuclear spin 102 is used as the inertial sensor, while the electronic spin 103 is used for initializing and reading out the nuclear spin 102 state.

FIG. 1B is a schematic illustration showing the behavior of the nuclear spin 102 and electronic spin 103 of the system 101 shown in FIG. 1A under a hyperfine enhanced regime. FIG. 1C is a schematic illustration showing the behavior of the nuclear spin 102 and electronic spin 103 of the system 101 shown in FIG. 1A under an inertial regime. Magnet 111 (shown in FIG. 1A) applies an external magnetic field B 104 in the direction of the z axis. While the NV spin (also referred to as “electronic spin”) 103 quantization axis \hat{z}_{NV} co-rotates with the diamond structure of electro-nuclear spin system 101 (resulting in rotation θ), the nuclear spin 102 of the atom(s) in the NV center either adiabatically follows its eigenstate under a slow rotation (φ′≠0 as shown in FIG. 1B), or remain in its initial state under a fast rotation (φ′=0 as shown in FIG. 1C).

As the system 101 experiences a rotation rate 112 of 22, the external magnetic field rotates relative to the frame of reference of the system 101 (also referred to herein as NV frame of reference or NV frame) and its component spins 102, 103. In the case of an applied rotation rate 112 about the y-axis shown in FIG. 1A, the applied magnetic field 104 B evolves (in the system's 101 frame of reference) from only having a z-axis component B, to having both a z-axis component (B_{z}) and an x-axis component (Bₓ). Diagrams 105a, 105b show the effect of the applied rotation rate 112 of Ω in the frame of reference of the system 101. Both regimes result in relative rotations (θ of the electronic spin 103 and φ′ of the nuclear spin 102) shown in diagrams 105a and 105b. This results in the angular difference between the nuclear spin 102 and the electronic spin 103 being dependent upon the rotation rate 112 of the system 101 and therefore said angular difference can be used to extract the rotation rate. Laser 110 can interact with system 101 and produce a fluorescent signal dependent upon said angular difference measurable using detector 114. In general, the direction of nuclear spin 102 is correlated with the effective magnetic field 104 B while the direction of the electronic spin 103 is correlated with the orientation of the system 101. Diagrams 105a and 105b also show the magnetic field B, in the inertial frame of reference and the corresponding x axis (Bₓ) and z axis (B_{z}) components in the system's frame of reference.

In the hyperfine-enhanced regime, shown in FIG. 1B, the hyperfine interaction between the electronic spin 103 and the nuclear spin 102 enhances the transverse Zeeman coupling of the nuclear spin 102 by a factor (α applied to the x-axis component, resulting in αBₓ) ranging from 15 to a few thousand (depending on the longitudinal component of the magnetic field 104). The factor α modifies the magnetic field 104 B into an effective magnetic field, B_{eff}, which can be used to boost the nuclear spin 102 rotation and thus the gyroscope sensitivity by the same enhancement factor, α. In the inertial regime, shown in FIG. 1C, hyperfine interaction does not occur, and the magnetic field 104 B remains in its original direction and magnitude.

Numerical simulations demonstrate that gyroscope 100 is robust against magnetic noise and only limited by the NV lifetime T₁ₑ. Besides rotation sensing, gyroscope 100 can provide insights into experimental tests of fundamental physics such as Lorentz invariance, relativistic geometric phases, and the Einstein de Haas effect.

The ground state Hamiltonian of the NV center of system 101 is

$$H = \vec{S} \cdot D \cdot \vec{S} + \vec{S} \cdot A \cdot \vec{I} + {γ}_{e} \vec{B} \cdot \vec{S} + {γ}_{n} \vec{B} \cdot \vec{I} \qquad ( 1 )$$

where D, A are zero-field splitting (ZFS) and hyperfine tensors, and γₑ=(2π)2.802 MHz/G, γₙ=(2π)0.432 kHz/G the gyromagnetic ratios of the electronic 103 and nuclear spin 102. When the \hat{z} axis is chosen to be along the N-to-V orientation \hat{z}_{NV}, both tensors are diagonal: the ZFS tensor has a longitudinal term D=(2π)2.87 GHz; the longitudinal and transverse components of the hyperfine tensor are A_{zz}=(2π)3.03 MHz and A_{⊥}=(2π)3.65 MHz.

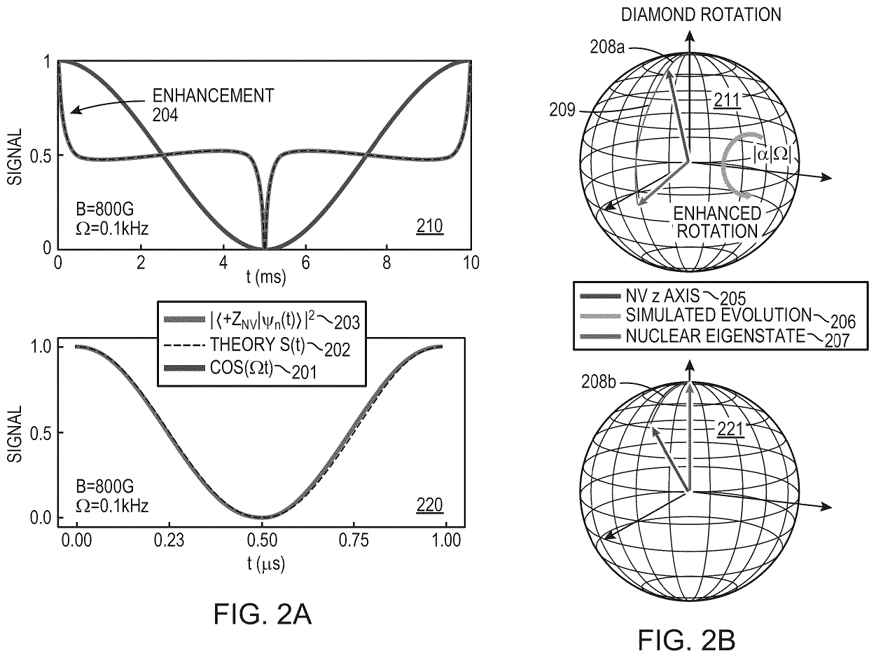

FIG. 2A is a graph 210, 220 showing the results of a simulation of the gyroscope protocol of the system 101 shown in FIG. 1A under a hyperfine enhanced regime and under an inertial regime. The simulation results under a hyperfine-enhanced regime are shown in graph 210 and occur when rotation rate 112 of the system is small compared to the magnetic field 104 (^{Ω}<<γₙB). The simulation results under an inertial regime are shown in graph 220 and occur when rotation rate 112 of the system is large compared to the magnitude of magnetic field 104.

Graph 210 shows the simulated results for a system 101 (also referred to herein as “diamond”) experiencing a rotation rate 112 of Ω=(2π)0.1 kHz and magnetic field 104 of B=800 G. Graph 220 shows the simulated results for a system 101 experiencing a rotation rate 112 of Ω=(2π)1 MHz and magnetic field 104 of B=50 G.

On both graph 210 and graph 220, line 201 shows the system 101 rotation (“diamond rotation,” at rate cos(^{Ω}t)), dotted line 202 represents the theoretical output of a signal (S(t)) measuring the overlap of nuclear spin 102 and electronic spin 103, and line 203 represents the simulated results of nuclear spin 102 population (|ψₙ(t) [symbol] ) along the along the NV axis (| [symbol] +z_{NV}|ψₙ(t) [symbol] |²). Because the electronic spin 103 remains fully quantized along only the NV axis (\hat{z}_{NV}), this nuclear spin 102 population (| [symbol] +z_{NV}|ψₙ(t) [symbol] |²) should be corelated with the signal (S(t)) measuring the overlap between the electronic spin 103 and nuclear spin 102. Signal S(t) can be measured by components, such as laser 110 microwave/radiofrequency source 113, and detector 114 of system 101, and used to determine the system's 101 rotation rate 112 (^{Ω}). As shown in graphs 210 and 220, the simulated results 203 of system 101 follow the expected theorical behavior 202. Under both regimes, at t=0 (before rotation 201 begins) the electronic spin 103 and nuclear spin 102 experience maximum overlap and signal S(t) 202 and nuclear spin 102 population (| [symbol] +z_{NV}|ψₙ(t) [symbol] |²) 203 are maximized. They both decrease until they reach a minimum point and then returns to the maximum when a complete rotation of system 101 occurs.

In the inertial regime shown in graph 220, system 101 behavior is relatively simple as the nuclear spin 102 remains correlated with an unaltered external magnetic field 104 and electronic spin 103 follows the NV axis (\hat{z}_{NV}) that rotates with the system 101 resulting in spin overlap, nuclear spin 102 population (| [symbol] +z_{NV}|ψₙ(t) [symbol] |²) 203, and theoretical signal S(t) 202 closely following system 101 rotation 201.

In the hyperfine-enhanced regime, shown in graph 210, the behavior of system 101 is altered due to the evolution of the magnetic field 104 B into the effective magnetic field B_{eff} which is affected by the rotation of system 101, due to the hyperfine interaction. The nuclear spin 102 is correlated with the resulting effective magnetic field B_{eff} resulting from the hyperfine interaction while electronic spin 103 still follows the NV axis (\hat{z}_{NV}) that rotates with the system 101. This results in an enhancement 204 where the change in the overlap of the electronic spin 103 state and nuclear spin 102 state is magnified even when system 101 rotation is small. This enhancement 204 increases the rate of decline of both nuclear spin 102 population | [symbol] +z_{NV}|ψₙ(t) [symbol] |²) 203, and signal S (t) 202, even at small rotations, and increases the ability of system 101 to measure and detect small or slow rotational changes.

FIG. 2B is a schematic illustration 211, 221 showing NV z axis (\hat{z}_{NV}) 205, nuclear spin evolution 206, and nuclear spin eigenstate 207 for the simulation of the gyroscope protocol of the system 101 shown in FIG. 1A under a hyperfine enhanced regime and under an inertial regime. NV z axis (\hat{z}_{NV}) 205 correlates to electronic spin 103 and follows the rotation 201 of system 101. Nuclear spin eigenstate 207 correlates to the quantized nuclear spin 102 and adiabatically follows the applied or effective magnetic field.

Schematic 221 shows system's 101 behavior under the inertial regime. In the inertial regime the nuclear spin 102 remains correlated with the static applied magnetic field 104 which results in a nuclear spin eigenstate 207 solely along the z-axis of the inertial frame of reference. Therefore, nuclear spin evolution 206 is non-existent. The NV z axis (\hat{z}_{NV}) 205 and the electronic spin 103 rotate 201 with the system at cos(^{Ω}t). The resulting difference 208b between the nuclear spin and electronic spin can be measured using signal S(t) and used to calculate the system's 101 rotation 201, cos(^{Ω}t), or rate of rotation 112, Ω.

Schematic 211 shows system's 101 behavior under the hyperfine-enhanced regime. In the hyperfine-enhanced regime nuclear spin 102 becomes correlated with an effective magnetic field B_{eff} resulting from the hyperfine interaction. The effective magnetic field B_{eff} experiences a larger rotation and rate of rotation than the system 101. Therefore, nuclear spin 102 experiences a significant evolution 206 and the nuclear eigenstate 207 is no longer directed solely along the z-axis of the inertial frame of reference. The NV axis (\hat{z}_{NV}) 205 and the electronic spin 103 still rotate 201 with the system at cos (^{Ω}t). The evolution 206 of the nuclear spin 102 and its eigenstate 207 result in an enhanced rotation 209 relative to the NV axis (\hat{z}_{NV}) 205 and the electronic spin 103. The enhanced rotation 209 has enhanced magnitude |α|Ω in comparison to the rotation of the system 101, cos (^{Ω}t), represented by the difference 208a between the NV axis (\hat{z}_{NV}) 205 and the z-axis (direction of the applied magnetic field 104). The enhanced rotation 209 increases the rate of change of the overlap of the electronic spin 103 state and nuclear spin 102, nuclear spin population along the NV axis (| [symbol] +z_{NV}|ψₙ(t) [symbol] |²) 203, and signal S(t) 202 providing increased inertial sensing sensitivity.

In an intermediate regime that can occur in environments between the inertial and hyperfine-enhancement regimes, it can be hard to attribute the population signal to either hyperfine-enhanced or inertial regimes.

Under an external magnetic field 104 \vec{B} satisfying γₑB<<D, the electronic spin is quantized along \hat{z}_{NV} by the large ZFS and is tied to the diamond crystal structure of system 101. In contrast, the nuclear spin 102 energy is defined by the external magnetic field and (if it exists) hyperfine interaction, with an effective Hamiltonian in the NV reference frame (the frame of reference where the z axis is defined by \hat{z}_{NV}).

$${H}_{I} = {γ}_{n} [ {B}_{z} {I}_{z} + {α}_{{m}_{s}} {B}_{x} {I}_{x} ] + {A}_{zz} {m}_{s} {I}_{z} , \qquad ( 2 )$$

where mis the electronic spin 103 Zeeman state and αₘis an enhancement factor of the transverse Zeeman energy induced by mixing with the electronic spin states due to the transverse hyperfine interaction. When the magnetic field B is small (γ ₑB<<D), such a factor can be approximated to a constant αₘ_{ₛ}=(1−2k+3kmₛ²) with k˜γₑA_{⊥}/(γₙD)˜8.26.

Ideally, when there is no external magnetic field 104 and mₛ=0, the nuclear spin 102 is effectively decoupled from the NV electronic spin 103 and a physical rotation of the diamond system 101 along a transverse direction ŷ rotates the electronic spin 103 eigenstates while leaving the nuclear spin 102 unchanged. When the rotation rate satisfies Ω<<D−γₑB, the NV electronic spin 103 state adiabatically follows the NV orientation axis \hat{z}_{NV}. In the NV frame, the nuclear spin 102 initialized to |mₗ=+½ [symbol] and rotates in the [symbol] -x plane with a rate -Ω due to its inertia. The nuclear spin 102 population projected onto the NV axis can be measured by mapping to the NV electronic spin 103 population with a CNOT gate, yielding a signal S(t)=(1+cos (Ωt))/2, from which the rotation rate can be extracted. Signal S (t) or an equivalent representation of the projection of the nuclear spin 102 onto the electric spin 103 can be measured using laser 110, microwave/radiofrequency source 113, detector 114 or any other equivalent components, tools, or methods known to those skilled in the art.

Embodiments utilizing this gyroscope protocol are attractive as they do not require gimbals however, working at a zero magnetic field can be challenging because of the need for magnetic shielding. In addition, working at zero magnetic field may make the nuclear spin 102 even more susceptible to magnetic noise, which is usually larger at lower frequencies and can lead to dephasing and depolarization. Thus, some embodiments utilize a general gyroscope 100 protocol for nonzero magnetic field conditions.

### Hyperfine-Enhanced Regime.

Adding a magnetic field improves the rotation sensing performance of embodiments by inducing, enhancing, or amplifying the nuclear spin 102 rotation. An external magnetic 104 field B is applied in a static reference frame, and first considered for sensing slow rotations Ω<<γₙB of the system 101. With the system 101 initially aligned with \hat{z}_{NV} axis along the direction of magnetic field 104 (B=B_{z}), both electronic spin 103 (mₛ) and nuclear spin 102 (mₗ) are initialized in z-eigenstates, |

$${m}_{s} = 0 , {m}_{I} = \frac{1}{2} 〉 .$$

When the system 101 rotates 112 along y axis (ŷ) by angle θ=Ωt, the ZFS and hyperfine tensors also rotate. Conversely, in the system's 101 frame of reference, the magnetic field 104 appears to acquire a transverse component (Bₓ as shown in FIGS. 1B and 1C). While the electronic spin 103 is still mainly quantized along \hat{z}_{NV}, the nuclear spin 102 adiabatically follows the magnetic field direction and similarly obtains a transverse component. As noted previously, in the hyperfine-enhanced regime, the applied magnetic field, B, is transformed into the effective magnetic field, B_{eff}, due to the hyperfine interaction. In the system's 101 frame of reference the effective magnetic field can be separated into components along the z-axis (\hat{z}_{NV}) and the x-axis (\hat{x}_{NV}) of the NV frame, as follows \vec{B}_{eff}=−α₀B sin θ\hat{x}_{NV}+B cos θe\hat{z}_{NV}. The effective magnetic field and therefore the nuclear spin 102 rotate with respect to the NV axis by an angle φ′ satisfying tan φ′=−α₀tan θ (as shown as element 105a in FIG. 1B). For θ<<1, the effective magnetic field and therefore the nuclear spin's 102 rotation in the NV frame is amplified by a factor of |φ′/θ|≈|α₀| due to hyperfine interaction, giving an effective rotation rate of the nuclear spin 102 in the inertial frame of reference of Ω(1+|α₀|), as shown by schematic 211 and enhancement element 209 in FIG. 2B. The rotation enhancement factor is magnetic-field dependent, increasing dramatically to its maximum value

$${α}_{0} \approx \frac{{γ}_{e}}{\sqrt{2} {γ}_{n}} \approx 4.6 \times {10}^{3}$$

near the GSLAC (ground-state level avoided crossing) condition when γₑB˜D.

To extract the rotation rate 112 12, embodiments measure the nuclear spin 102 population along the \hat{z}_{NV} axis by mapping the nuclear spin 102 state onto the NV axis, yielding a signal shown below.

$$S ( t ) = \frac{1 + cos {φ}^{′} ( t )}{2} = \frac{1}{2} ( 1 + \frac{cos Ω t}{\sqrt{{cos}^{2} Ω t + {α}_{0}^{2} {sin}^{2} Ω t}} ) \qquad ( 3 )$$

Signal S(t) or an equivalent representation of the projection of the nuclear spin 102 onto the electric spin 103 can be measured using laser 110, microwave/radiofrequency source 113, detector 114 or any other equivalent components, tools, or methods known to those skilled in the art.

FIG. 2A provides a numerical simulation of the evolution of the gyroscope system 101 under a rotation rate 112 Ω=(2π)100 Hz with an external magnetic field 104 B=800 G. The evolutions of the NV axis (\hat{z}_{NV}) components of electronic spin 103 and nuclear spin 102 are separated by tracing out the other spin. The simulated nuclear spin 102 population along z_{NV} is shown by lines 203, matching the theoretical prediction 202 of signal S(t). The enhancement 204 effect in the simulations is a result of the nuclear spin 102 adiabatically following the effective magnetic field. The nuclear spin 102 rotation enhancement 209 factor matches the theoretically predicted enhancement factor |α₀|.

When the nuclear Larmor precession frequency is comparable to the rotation rate, Ω˜γₙ B, the adiabaticity of the nuclear spin 102 evolution begins to break down (for example at Ω=(2π)0.5 kHz), and it no longer follows the effective magnetic field. To further study such effects, simulations over different rotation rates for a fixed magnetic field were compared. For each rotation rate Ω≤γₙB, the average deviation from the theoretical predicted signal of Eq. (3) was computed as well as the eigenstate deviation

$${\vert 〈 + \frac{1}{2} \vert \frac{{dH}_{I} ( t )}{dt} \vert - \frac{1}{2} 〉 \vert}^{2}$$

(where (mₗ=±½ [symbol] are the nuclear spin eigenstates). As the system 101 rotation rate 112 increases, the eigenstate deviation increases and after a threshold value, it becomes difficult to directly extract the rotation rate from the measured signal as the measured signal no longer matches the theoretical predicted signal of Eq. (3). To maintain the adiabaticity and sense faster rotations in the hyperfine-enhanced regime, embodiments can increase the bias magnetic field to increase the nuclear spin 102 energy gap. Quantifying the nuclear eigenstate deviation allows one to define a bespoke maximum rotation rate that embodiments can detect for a given magnetic field and desired signal precision.

### Inertial Regime

While the enhanced rotation factor 209 is limited to sensing a rotation rate 112 that is much less than the nuclear spin 102 energy gap, embodiments of the disclosed gyroscope protocol can still sense rotation rates in the regime where Ω>>γₙB. Here, the electronic spin 103 is quantized along \hat{z}_{NV} and still follows the system's 101 rotation adiabatically. The effective external magnetic field 104 on the nuclear spin 102 rapidly oscillates and averages to zero similar to the B=0 case, so the nuclear 102 spin remains in its initial state (for example along the inertial frame's z-axis). In this scenario, the relative rotation observed between the two spins 102, 103 corresponds directly to the system's 101 rotation 112, yielding a nuclear spin 102 population signal along \hat{z}_{NV},

$$S ( t ) = \frac{1}{2} ( 1 + cos θ ) = \frac{1}{2} ( 1 + cos ( Ω t ) ) . \qquad ( 4 )$$

The evolution of the system 101 was simulated under a fast rotation Ω=(2π)1 MHz and the results are shown in FIG. 1C, graph 220 of FIG. 2A and schematic 221 of FIG. 2B. As shown in graph 220 of FIG. 2A, the simulated results 203 were consistent with the theoretical prediction 202 of Eq. (4). Similar to the hyperfine-enhanced regime, calculating the nuclear spin 102 eigenstate deviation identifies the minimum rotation 112 rate required for high-fidelity measurements in this regime.

Thus, combining both regimes, embodiments of the gyroscope 100 accurately measure a broad dynamic range Ω{tilde under (<)}D−γₑB, except for a small window near the nuclear spin 102 energy gap Ω˜ΓₙB. To maximize the enhanced rotation rate 209 in the hyperfine-enhanced regime, one can choose to set the bias magnetic field strength as close as possible to GSLAC. Nevertheless, at magnetic high strength fields, misalignment of the electronic spin 103 from the magnetic field, as well as its small energy gap, can make initialization and readout of the protocol difficult. The following discusses and analyzes such limits to the sensitivity of embodiments, for example system 101, including their ultimate lifetime and optimal performance.

### Gyroscope Performance

Quantum sensors' (such as those used to measure nuclear spin 102 of system 101) performance is bounded by their coherence or relaxation times, which limits the sensing time t. In the enhanced rotation or hyperfine-enhanced regime, the nuclear spin 102 adiabatically follows its eigenstate, correlated with the effective magnetic field, and thus its decay induced by an external bath follows a spin relaxation process with a relaxation time T₁ₙ typically much longer than the dephasing time T₂ₙ^{*}. However, under rotation of system 101, the electronic spin 103 flips (from mₛ to m′ₛ) due to relaxation which changes the nuclear spin 102 quantization axis (See Eq. (2)) and can lead to a decay of what was previously a stable eigenstate. This process can be numerically simulated using the following Lindblad equation with Lindblad operators Lₖ=\sqrt{Γ}|mₛ [symbol] [symbol] m′ₛ|, where mₛ, m′ₛ ϵ{−1, 0,+1} and the jump rate is Γ=1/(3T₁ₑ).

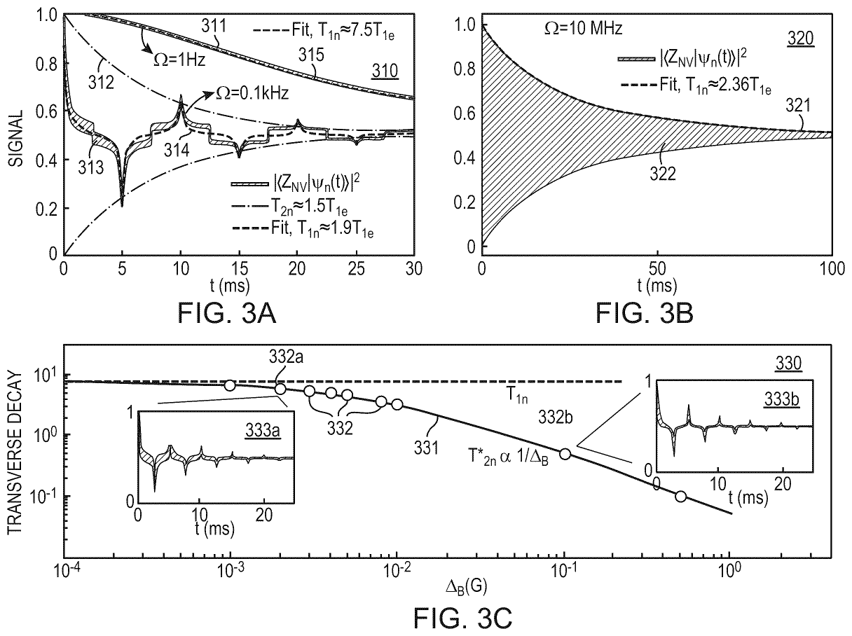

FIG. 3A is a graph 310 of a coherence analysis for a gyroscope signal under electronic spin 103 T1 relaxation in a hyperfine-enhanced regime according to an example embodiment. In the shown analysis, magnetic field B=50 G and the signal produced by the nuclear spin 102 population along the NV axis (| [symbol] +z_{NV}|ψₙ(t) [symbol] |²) over time was simulated both under a rotation rate Ω=(2π)1 Hz, represented by solid line 311, and a rotation rate 112 Ω=(2π)0.1 KHz<<γₙB, represented by line 313. The simulated nuclear spin signals 311, 313 are compared to fit to S(t)=c₀+c₁e^{-(t/T}^{₁ₙ}⁾^{^{c}}^{₂} (2| [symbol] z_{NV}|ψₙ(t) [symbol] |²−1) to measure decay where T₁ₙ≈7.5T₁ₑ is shown by dashed fit line 315, and T₁ₙ≈1.9T₁ₑ is shown by dashed fit line 314. Dashed line 312 plots nuclear spin coherence time (T₂ₙ) as T₂ₙ=1.5T₁ₑ where T₁ₑ is the electronic spin relaxation time. T₂ₙ establishes the performance limit of prior art gyroscope scheme based on nuclear spin Ramsy sequences. Graph 310 shows that in the slow rotation (simulated signal 311) hyperfine-enhanced regime the gyroscope signal decay time is T₁ₙ{tilde under (>)}1.5T₁ₑ (e.g., dashed fit lines 314, 315), with longer coherence achieved for the slower rotations.

FIG. 3B is a graph 320 of a coherence analysis for a gyroscope signal under electronic spin T1 relaxation in an inertial regime according to an example embodiment. In the shown analysis, magnetic field B=50 G and the signal 321 (solid line) produced by the nuclear spin 102 population along the along the NV axis (| [symbol] +z_{NV}|ψₙ(t) [symbol] |²) over time was simulated under a rotation rate 112 Ω=(2π)10 MHz. This simulated nuclear spin signal is compared to fit to S(t)=c₀+c₁e^{-(t/T}^{₁ₙ}⁾^{^{c}}^{₂} cos (Ωt) to measure decay where T₁ₙ≈2.36 T₁ₑ is shown by dashed fit line 322. In the inertial regime under fast rotations, as shown FIG. 3B, the simulation yields a decay time T₁ₙ>1.5T₁ₑ. This increased decay time might originate from dynamical decoupling effects due to the electronic spin's 103 rapid rotation.

FIG. 3C is a graph 330 of the simulated decay time 331 of the transverse evolution of the nuclear spin 102 as a function of magnetic noise strength according to an example embodiment. In both regimes, the identified signal's 311, 313, 321 decay is due to the electronic spin 103 relaxation process as well as magnetic noise (e.g. induced by the spin bath) which can both affect the coherence of the spin system. Graph 330 displays the results of simulations of the gyroscope signal in the presence of both sources of decay. Graph 330 plots decay time T₂ₙ^{*} of the transverse evolution of the nuclear spin 102 as a function of the magnetic noise strength (Δ_{B}) assuming T₁ₙ=7.5 ms. Inserts 333a, 333b show example gyroscope signals at Δ_{B}=0.002 G (333a) and Δ_{B}=0.1 G (333b). Line 331 is fitted to simulated results 332, such as point 332a and 332b shown in inserts 333a, 333b.

In the frame reference of the nuclear spin 102, the longitudinal magnetic noise causes a T₂ₙ^{*} dephasing process that results in a decay only of its transverse spin components. Intuitively, this might lead to a decay of the longitudinal spin component as well; however, even though the fast oscillation decays with time, the signal of system 101 measured by gyroscope 100 remains relatively robust against the magnetic noise. Such an effect may even improve the performance of embodiments of the gyroscope 100 by suppressing the undesired fast oscillation signal that originates from the spin precession around the effective magnetic field.

Thus for some embodiments, the gyroscope's 100 signal decay is ultimately limited by the lifetime T₁ₙ, giving a lower bound of the achievable sensitivity of the gyroscope 100

$$η \geq \frac{\sqrt{2} {γ}_{n}}{{γ}_{e}} \frac{{e}^{t / {T}_{1 n}}}{C \sqrt{N}} \frac{\sqrt{t + {t}_{d}}}{t} , \qquad ( 5 )$$

in the hyperfine-enhanced regime, where t is the sensing time and t_{d} is the dead time. With typical ensemble parameters and conditions (readout efficiency C˜2%), for a volume V=1 mm³ and N=n_{NV}V/4˜2.5×10¹⁴ sensor spins and T₁ₙ˜7.5 ms, the sensitivity limit reaches n˜1×10⁻³(mdeg/s)/\sqrt{Hz} near GSLAC. In the inertial regime, the sensitivity follows Eq. (5) but without the enhancement factor ˜γₙ/(\sqrt{2γₑ}).

Implementation of some embodiments of the gyroscope 100 requires considering other experimental limitations; the following briefly discusses these factors and their influence on the sensitivity of gyroscope 100 and system 101. To take advantage of the hyperfine-enhanced rotation rate 209, the time for signal readout should be chosen such that the two spins 102, 103 are nearly aligned, as the enhancement decreases with rotation angle away from kπ. This is similar to the (periodic) optimal measurement time used for Ramsey-based gyroscopes. Furthermore, under large magnetic fields, optical polarization of the electronic spin 103 is difficult with misalignment from the magnetic field 104. Thus, to operate embodiments of gyroscope 100 continuously, both the dead time and sensing time can be limited to integer multiples of the rotation period t+t_{d}≈kπ/Ω, guaranteeing that the electronic spin 103 is nearly aligned with the magnetic field 104 during initialization and readout. For these calibrations, an initial estimation of the rotation rate would be beneficial (e.g., by using the electronic spin 103 transition frequency shift during the rotation). A more complete sensitivity analysis considering these factors is included below.

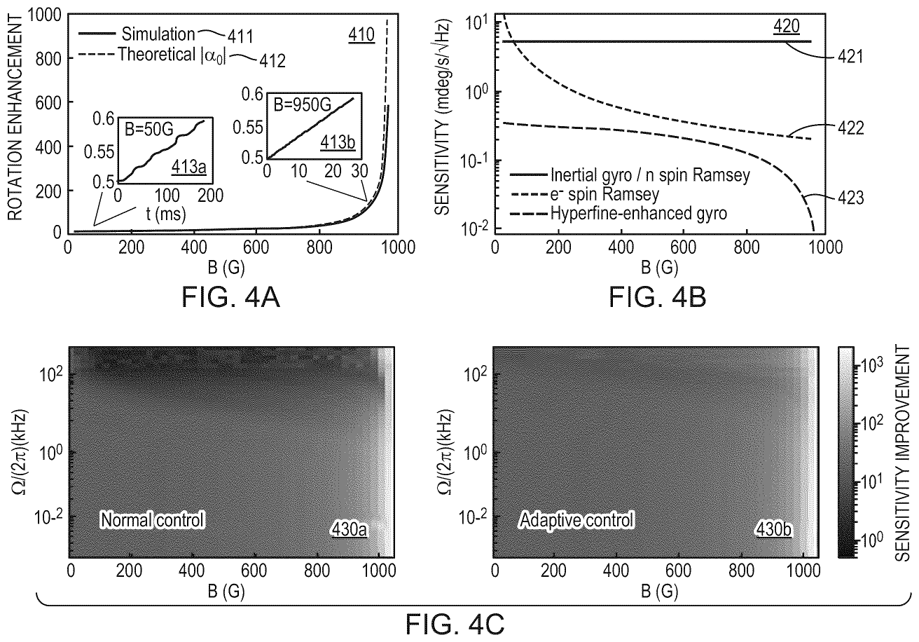

FIG. 4A is a graph 410 of the simulated 411 and theoretical 412 rotation enhancement factor of the nuclear spin 102 as a function of applied magnetic field 104 according to an example embodiment. In the hyperfine-enhanced regime, the rotation rate of nuclear spin 102 of system 101 is enhanced 209 by the resulting effective magnetic field B_{eff} as shown FIGS. 1B, 2A, and 2B. Graph 410 plots the simulated 411 and theoretical 412 rotation enhancement factor |α₀| as a function of applied magnetic field 104. The insets 413a, 413b show two exemplary simulations of the evolution of the nuclear spin 102 population along \hat{x}_{NV} over time at B=50 G and B=950 G.

FIG. 4B is a graph 420 of a comparison of the ideal sensitivity of gyroscope protocols under typical conditions, including an example embodiment. Graph 420 plots sensitivity as a function of the applied magnetic field for a prior art nuclear spin Ramsy gyroscope 421, a prior art electronic spin Ramsy gyroscope 422, and an example embodiment of gyroscope 100 under a hyperfine enhancement regime 423. The same readout efficiency C=2% is used across all compared gyroscope protocols 421, 422, 423. For nuclear spin-based gyroscope protocols 421, 423, the signal decay times were set to 1.5T₁ₑ=7.5 ms and dead time to t_{d}=0.5 ms. The electronic spin Ramsy gyroscope 422 protocol utilizes the NV electronic spin 103 resonance frequency shifts measured by a Ramsey sequence to sense the rotation rate, where a typical spin dephasing time T₂ₑ^{*}=0.7 μs and t_{d}=0.05 ms was used.

FIG. 4C is a set of heat maps 430a, 430b showing sensitivity improvements, provided by example embodiments using hyperfine-enhanced gyroscope protocols, over prior art nuclear Ramsey protocols taking into account the fidelity of normal and adaptive quantum controls. Heat map 430a shows improvements in normal quantum control, and heat map 430b shows improvements in adaptive quantum control. In both scenarios, the Rabi driving strength is 1 MHz.

In embodiments of gyroscope 100, initialization and readout of the nuclear spin 102 requires selective control of the electronic spin 103 such as π-pulses only for a specific nuclear spin 102 state. Thus, for practical operation under continuous rotation conditions, it is important to consider the control fidelity degradation due to the resonance frequency shift especially when the rotation rate 112 is fast. Considering these effects, when creating heat maps 430a, 430b the rotation enhancement is multiplied by a fidelity factor in to characterize the sensitivity improvement of the embodiments of hyperfine-enhanced gyroscope 100/system 101 compared to the prior art Ramsey-based gyroscope as a function of system 101 rotation and magnetic field 104 (Ω,B). Not only do heat maps 430a, 430b show an improved performance, but the improvement's decline at higher rotation rates can be compensated by using optimal control and adaptive techniques. For example, for the adaptive control heat map 430 b, the driving frequency is varied in real-time to follow the NV resonance during the system 101 rotation, showcasing a robust performance over a broader range of rotation rates. Thus, embodiments of gyroscope 100/system 101 remains a versatile platform with extremely good sensitivity and a broad dynamic range.

With the assistance of an external magnetic field 104, the NV electronic spin 103 transition frequency can also be used to extract the transverse rotation rate, e.g. by electronic spin Ramsey experiments limited by a dephasing time T₂ₑ^{*}. In a spin ensemble, T₂ₑ^{*} is typically short T₂ₑ^{*}<<T₁ₑ and thus the sensitivity is worse than embodiments of the hyperfine-enhanced nuclear spin gyroscope 100 disclosed herein.

### Conclusion

Disclosed herein is a novel gyroscope 100 utilizing a protocol based on ¹⁵NV centers in a diamond dual spin system 101. In comparison to prior art Ramsey-type gyroscopes limited to sensing a \hat{z} rotation and suffering from spin dephasing, the disclosed embodiments' protocol uses the more robust population state of nuclear spin 102 along the NV axis (\hat{z}_{NV}) to sense transverse rotation. When an external magnetic field 104 is fixed in the lab frame, the nuclear spin 102 rotation rate can be significantly enhanced 209 by its hyperfine interaction with the electronic spin 103, achieving a sensitivity improvement of up to three orders of magnitude compared to prior art gyroscopes that use nuclear Ramsey schemes. Embodiments of gyroscope 100 are robust against magnetic noise and are only limited by T₁ relaxation times.

While analysis shows that nuclear spin lifetime T₁ₙ is still ultimately limited by the electron spin 103 T₁ₑ relaxation time, which is also the ultimate limit to the coherence limit of the prior art Ramsey-type gyroscope, embodiments of gyroscope 100 are intrinsically more robust to other sources of dephasing noise that dominate prior art Ramsey gyroscopes and provide an additional, significant sensitivity improvement due to the rotation enhancement 209 created by the hyperfine interaction. Sensitivity of gyroscope 100 may be further improved by a better understanding of the dependence of T₁ₙ under adiabatic evolution (which can be substantially longer than T₁ₑ−limited T₂ₙ^{*}) and by utilizing dynamical decoupling techniques to extend the nuclear spin lifetime beyond The by canceling the deleterious effects of the electronic spin 103 relaxation process.

In addition to providing a highly sensitive and compact gyroscope 100 under ambient conditions competitive with atomic gyroscopes, embodiments can also exploit the electro-nuclear spin system 101 to provide insights into testing fundamental physics. Thus, embodiments of gyroscope 100 prove to be a robust and versatile device, with broad opportunities for integration and applications.

### Derivation of Enhancement Factor

The following is a derivation of the exact expression for the transverse Zeeman coupling enhancement factor 209 of the nuclear spin 102 for the ¹⁵NV center system 101 for ms=0. The ground state Hamiltonian is provided by Equation 1.

$$H = \vec{S} \cdot D \cdot \vec{S} + \vec{S} \cdot A \cdot \vec{I} + {γ}_{e} \vec{B} \cdot \vec{S} + {γ}_{n} \vec{B} \cdot \vec{I} , \qquad ( 1 )$$

Under an applied magnetic field B_{z}, the Hamiltonian can be decomposed into secular H_{∥}and non-secular terms H_{⊥}:

$${H}_{∥} = {DS}_{z}^{2} + {γ}_{e} {B}_{z} {S}_{z} + {γ}_{n} {B}_{z} {I}_{z} + {A}_{zz} {S}_{z} {I}_{z} \qquad ( 6 )$$

$${H}_{⊥} = {A}_{⊥} ( {S}_{x} {I}_{x} + {S}_{y} {I}_{y} ) , \qquad ( 7 )$$

which drives the zero quantum (ZQ) transitions

$$\vert + 1 , - \frac{1}{2} 〉 ↔ \vert 0 , + \frac{1}{2} 〉 and \vert 0 , - \frac{1}{2} 〉 ↔ \vert - 1 , + \frac{1}{2} 〉 ,$$

The total Hamiltonian can be diagonalized by rotating these ZQ subspaces with U_{ZQ=e}^{-i(θ}^{^{−}}^{σ}^{_{y}}^{^{−}}^{-θ}^{⁺}^{σ}^{_{y}}^{⁺}⁾ where

$${σ}_{y}^{+} = i ( \vert + 1 , - \frac{1}{2} 〉 〈 0 , + \frac{1}{2} \vert - \vert 0 , + \frac{1}{2} 〉 〈 + 1 , - \frac{1}{2} \vert ) and \qquad ( 8 )$$

$${σ}_{y}^{-} = i ( \vert 0 , - \frac{1}{2} 〉 〈 - 1 , + \frac{1}{2} \vert - \vert - 1 , + \frac{1}{2} 〉 〈 0 , - \frac{1}{2} \vert ) and$$

$$tan ( 2 {θ}^{+} ) = \frac{{A}_{⊥}}{{D}_{+ 1}} tan ( 2 {θ}^{-} ) = \frac{A ⊥}{{D}_{- 1}}$$

with

$${D}_{{m}_{s}} = \frac{1}{2} ( D + {m}_{s} {B}_{z} ( {γ}_{e} - {γ}_{n} ) - {A}_{zz} / 2 ) .$$

Upon diagonalization, the Hamiltonian can be written as Ĥ_{z}=U_{ZQ}(H₈₁+H_{⊥})U_{ZQ}^{†}, with

$${\hat{H}}_{z} = {\sum }_{{m}_{s}} [ {γ}_{n} {B}_{z} + {m}_{s} {A}_{zz} + {δ}_{{m}_{s}} ] \vert {m}_{s} 〉 〈 {m}_{s} \vert {I}_{z} , \qquad ( 9 )$$

where the frequency shift is

$${δ}_{{m}_{s}} = {m}_{s} {D}_{{m}_{s}} ( 1 - \sqrt{1 + {A}_{⊥}^{2} /} {D}_{{m}_{s}}^{2} ) + ( 1 - \vert {m}_{s} \vert ) [ {D}_{+ 1} ( 1 - \sqrt{1 + {A}_{⊥}^{2} / {D}_{+ 1}^{2}} ) - {D}_{- 1} ( 1 - \sqrt{1 + {A}_{⊥}^{2} / {D}_{- 1}^{2}} ) ] \qquad ( 10 )$$

Applying an additional transverse magnetic field in the NV frame of reference (for simplicity and in context with the rest of the disclosure, only Bₓ is discussed, but a magnetic field component B_{y} would see an equivalent enhancement) introduces an interaction Hamiltonian Hₓ=Bₓ(γₑSₓ+γₙIₓ). The unitary transformation U_{ZQ} brings a contribution of Sₓ (which only couples different NV manifolds) inside each NV manifold, thus enhancing the nuclear spin Iₓ components. By neglecting terms mixing the subspaces, one obtains a block diagonal Hamiltonian, Ĥₓ=U_{ZQ}HₓU_{ZQ}^{†}≈γₙBₓIₓΣmₛαₘ|mₛ [symbol] [symbol] mₛ| with

$${α}_{\pm 1} = cos ( {θ}^{\pm } ) + \frac{{γ}_{e}}{{γ}_{n}} sin ( {θ}^{\pm } ) \qquad ( 11 )$$

$${α}_{0} = cos ( {θ}^{+} ) cos ( {θ}^{-} ) - \frac{{γ}_{e}}{{γ}_{n}} sin ( {θ}^{+} + {θ}^{-} ) \qquad ( 12 )$$

$${\hat{H}}^{{m}_{s}} = ( {γ}_{n} {B}_{z} + {m}_{s} {A}_{zz} {I}_{z} + {δ}_{{m}_{s}} ) {I}_{z} + {α}_{{m}_{s}} {γ}_{n} {B}_{x} {I}_{x} \qquad ( 13 )$$

In particular, the enhancement 209 α₀ in the mₛ=0 subspace is α₀≈15.5 even at small fields and reaches a finite maximum value near GSLAC with

$${α}_{0} \approx \frac{{γ}_{e}}{\sqrt{2 {γ}_{n}}} .$$

The gyroscope 100 signal is then

$$\frac{1}{2} ( 1 + \frac{{γ}_{n} {B}_{z} + {δ}_{0}}{\sqrt{{( {γ}_{n} {B}_{z} + {δ}_{0} )}^{2} + {( {γ}_{n} {B}_{x} {α}_{0} )}^{2}}} )$$

where δ₀ is instead 3 orders of magnitude smaller.

This approach works well for fields away from the ground-state level avoided crossing (GSLAC). Indeed, around the GSLAC one cannot neglect anymore the off block-diagonal terms in U_{ZQ}SₓU_{ZX}^{†}. If necessary, these terms can be taken into account by applying a quasi-degenerate perturbation theory.

### Derivation of Frequency Shift

Quasi-degenerate perturbation theory is a useful method to perturbatively diagonalize general Hamiltonians whether in the presence or not of degeneracy. It is particularly useful in the case where one can identify subspaces with (quasi-) degenerate eigenvalues and the aim is to block-diagonalize. The following derivation considers an unperturbed Hamiltonian H₀ with eigenstates |k⁰ [symbol] which can be grouped into sets, {|k⁰ [symbol] }≡{|k_{α}⁰ [symbol] }, {|k_{β}⁰ [symbol] }, {|k_{γ}⁰ [symbol] }, . . . }.

The perturbation Hamiltonian H′ can then be separated into terms that connect (unperturbed) eigenstates in each set, H_{d} and terms that describe couplings between the subspaces, Hₓ. Assuming energy differences between subspaces is large, one can treat Hₓ perturbatively.

Similar to the Schrieffer-Wolf transformation, one wants to find a similarity transformation, e^{-s}, such that Ĥ=e^{-s}He^{s} is block-diagonal. S=S⁽¹⁾+S⁽²⁾+S⁽³⁾+ . . . can be explicitly constructed order-by-order by expanding Ĥ in terms of nested commutators and imposing the block-diagonalization condition. This yields explicit expressions for the perturbative orders of Ĥ,

$${\hat{H}}^{( 0 )} = {H}_{0} , {\hat{H}}^{( 1 )} = {H}_{d} \qquad ( 14 )$$

$${\hat{H}}_{{k}_{α} {h}_{α}}^{( 2 )} = \frac{1}{4} {\sum }_{{j}_{β} \neq α} {H}_{{k}_{α} , {j}_{β}} {H}_{{j}_{β} , {h}_{α}} [ \frac{1}{{H}_{{k}_{α} , {k}_{α} - {H}_{{j}_{β} , {j}_{β}}}} + \frac{1}{{H}_{{h}_{α} , {h}_{α} - {H}_{{j}_{β} , {j}_{β}}}} ] \qquad ( 15 )$$

The derivation of Equation 13 neglected the components of Ĥₓ that mix different electronic manifolds. They can now be accounted for by perturbatively using the formalism just discussed. This results in a frequency shift δ′ₘ_{ₛ}, while there is no first-order correction to Iₓ. The shift δ′₀, becomes larger than α₀ for B_{z} close to the GSLAC and θ>0. This first-order approximation, which can be obtained analytically, is enough to capture the gyroscope 100 evolution for field B{tilde under (<)}950 G.

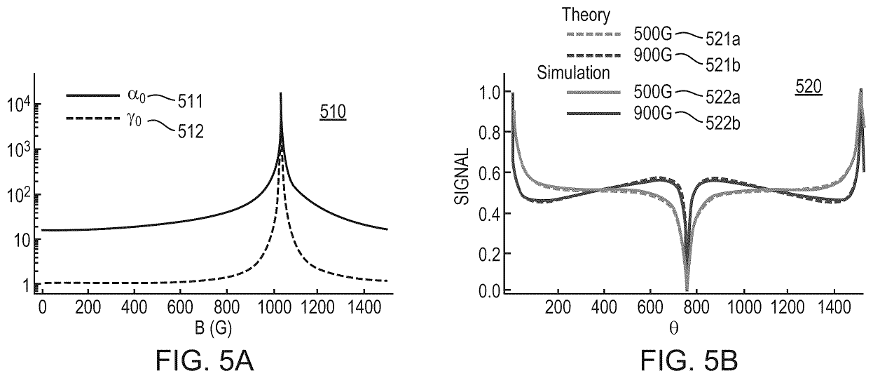

FIG. 5A is a graph 510 of the predicted enhancement factor 511, |α₀|, and frequency shift 512, δ′₀/γₙBₓ, for a system 101 rotation of θ=π/20 as a function of magnetic field 104 B of a gyroscope 100 according to an example embodiment. The predicted enhancement factor 511 and frequency shift 512 were calculated using the Equations 6-15 detailed above.

FIG. 5B is a graphed comparison of the simulated 522a, 522b and theoretical 521a, 521b values of signals produced by a gyroscope 100 external magnetic field 104 according to an example embodiment. The data displayed in graph 520, incorporates that of the predicted enhancement factor 511 |α₀| and frequency shift 512 calculated using the Equations 6-15 and detailed above as well as simulated data of the behavior of system 101 of gyroscope 100 for magnetic field B=500 G (521a, 522a) and B=900G (521b, 522b). As shown in graph 520, the solid lines simulated results 522a, 522b match the dashed lines theoretical predictions 521a, 521b.

### Protocol Details

### A. Nuclear Polarization and Readout

There are several methods to polarize the nuclear spin 102 intrinsic to the NV center of system 101: one can optically pump the nuclear spin 102 by setting the static magnetic field 104 close to the ground or excited level crossing of the atoms of system 101, or one can use a sequence of selective microwave and radiofrequency pulses (e.g., from source 113) to transfer polarization to the nuclear spin 102 from the electronic spin 103. However, under misalignment of the electronic spin 103, optical polarization of the nuclear spin 103 is significantly suppressed. Thus to achieve efficient polarization of the nuclear spin 103 in embodiments of gyroscope 100 utilizing the sensing protocols disclosed herein, especially in the case of initialization during a system 101 rotation 112 (which can cause the misalignment), it may be preferable to polarize the nuclear spin 102 to

$$\vert {m}_{I} = + \frac{1}{2} 〉$$

using a polarization sequence that coherently transfers the electron polarization to the nuclear spin 102.

Working in the mₛ=0, −1 states, embodiments may first transfer the population (“population” herein refers to the collective electronic 103 and nuclear 102 spin states of the system 101 comprised of atom(s) within a NV center) of system 101 from the

$$\vert {m}_{S} = 0 , {m}_{I} = - \frac{1}{2} 〉$$

spin state to

$$\vert {m}_{S} = - 1 , {m}_{I} = - \frac{1}{2} 〉$$

using a selective microwave (mw) π-pulse (generated, for example from source 113) with a Rabi frequency smaller than the hyperfine splitting strength. Embodiments then apply a selective radiofrequency (rf) π-pulse (generated, for example from source 113) that transfers the

$$\vert {m}_{S} = - 1 , {m}_{I} = - \frac{1}{2} 〉$$

population of system 101 to

$$\vert {m}_{S} = - 1 , {m}_{I} = - \frac{1}{2} 〉 .$$

Finally, a green laser pulse (generated, for example laser 110) is applied to transfer the population of system 101 back to the |mₛ=0 [symbol] manifold while preserving the nuclear spin 102 state. The system 101 is ultimately polarized to

$$\vert {m}_{S} = 0 , {m}_{I} = + \frac{1}{2} 〉$$

as an initial state of the rotation sensing protocol.

Optical readout of the nuclear spin 102 state can be accomplished with microwave mapping pulses (e.g., from source 113) at the end of the pulse sequence. This results in an outputted signal that corresponds to the nuclear spin 102 population along the NV axis (| [symbol] +z_{NV}|ψₙ(t) [symbol] |²), as shown in FIG. 2A, which in turn can be used to determine the rotation rate Ω 112 of system 101, as shown in FIG. 2B. To achieve efficient initialization and readout, embodiments prefer the NV axis to be closely aligned with the magnetic field when performing the initialization and readout operations.

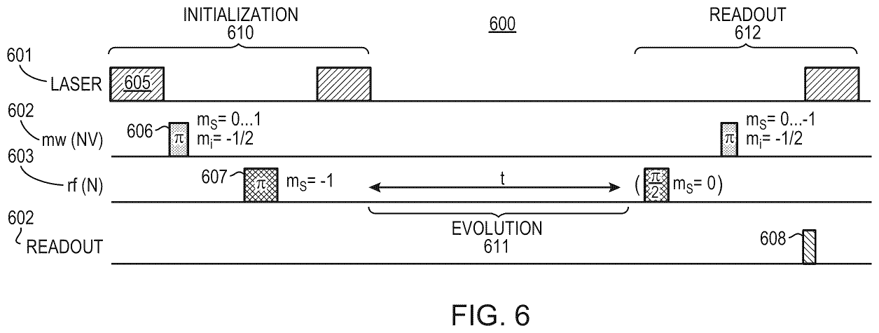

FIG. 6 is a timeline 600 of initialization 610, evolution (system rotation) 611, and readout 612 of a gyroscope 100 displaying the utilized laser 605, microwave 606, and radiofrequency 607 pulses according to an example embodiment. The pulses can be provided by laser 601, microwave source 602, and radiofrequency source 603, for non-limiting example the laser 110 and microwave/radiofrequency source 113 shown in FIG. 1. During initialization the nuclear spin 102 of system 101 is dynamically polarized using selective laser 605, microwave 606, and radiofrequency 607, pulses to achieve the desired system population, for example

$$\vert {m}_{S} = 0 , {m}_{I} = + \frac{1}{2} 〉 .$$

It would be clear to one skilled in the art that an alternative sequence or combination of pulses 605, 606, 607 can be used to achieve any desired system 101 population.

During evolution (system rotation) 611, the system 101 experiences rotation during time t resulting in the evolution of the electronic spin 103 and nuclear spin 102, as shown in FIGS. 1B, 1C, and 2B. After time t and during readout 612, the nuclear spin 102 is mapped onto the NV axis and overlap with the electronic spin 103 is readout 604 to extract the rotation rate, producing readout signal 608, for example signal S(t) shown in Equations 3 and 4, that can be used to derive rate of system rotation 112 Ω or system rotation θ. During readout 612, a microwave pulse 606 can be used as a mapping pulse to determine nuclear spin 102 and electronic spin 103 overlap. Readout signal 608 can be produced using a combination of laser 605, microwave 606, and radiofrequency 607 pulses. Readout signal 608 can be a fluorescent signal produced by the nuclear-electronic dual spin system's (e.g., system 101) interaction with laser 605 and representative of the angular difference of the nuclear spin 102 and electronic spin 103.

### Mapping Pulse Fidelity

Although most existing sensing protocols assume the target object to be sensed (e.g., dc or ac magnetic fields) can be turned on/off during the readout time 612 and does not affect the pulse 605, 606, 607 fidelity for state readout 604, the following analyzes a more practical sensing scenario when the system 101 is operated under continuous (instead of pulsed) rotation. The transition frequencies of the NV electronic 103 and nuclear spins 102 change during the rotation of system 101 due to their misalignment with the magnetic field 104 in the NV frame of reference and thus can affect the pulse 605, 606, 607 fidelity for the readout sequence 612 utilizing a mapping pulse (such as microwave pulse 606 within readout sequence 612) to map the population from nuclear spin 102 to electronic spin 103.

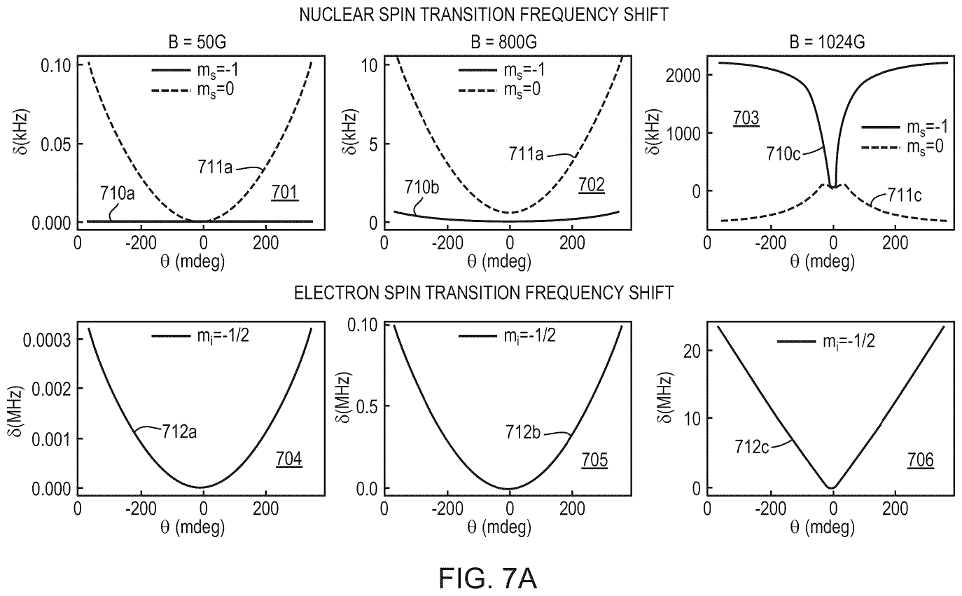

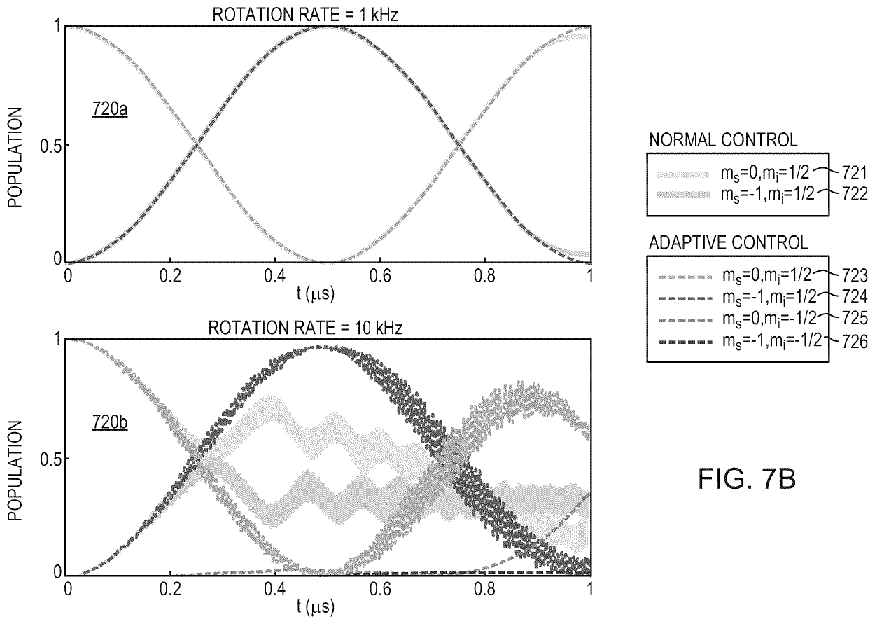

FIG. 7A is a set of graphs 701-706 that map the electronic spin 103 and nuclear spin 102 transition frequencies (δ) as a function of magnetic field misalignment θ at different magnetic field strengths. Graphs 701, 702, 703 map the nuclear spin 102 transition frequencies for |mₛ=−1 [symbol] (710a, 710b, and 710c) and |mₛ=0 [symbol] (711a, 711b, and 711c). Graphs 704, 705, 706 map the electronic spin 103 transition frequencies for |m_{I}=−½ [symbol] (712a, 712b, and 712c). When the magnetic field is larger, the transition frequency changes faster with field misalignment, leading to worse mapping fidelity.

To quantitatively calculate mapping microwave pulse 606 fidelity, one can numerically simulate the nuclear spin 102 evolution for its two initial states,

$${m}_{I} = \pm 1 / 2 , \vert {ψ}_{\pm \frac{1}{2}} ( {t}_{π} ) = {U}_{map} ( {t}_{π} , 0 ) \vert {m}_{S} = 0 , {m}_{I} = \pm 1 / 2 ,$$

where Uₘₐₚ(t_{π}, 0) describes the evolution of the mapping microwave pulse 606 under a physical rotation rate 112 Ω and magnetic field 104 B, and t_{π}is the microwave π-pulse duration, which can be calibrated using simulation. Ideally when the mapping microwave pulse 606 is perfect, one has

$$\vert {ψ}_{\frac{1}{2}} ( {t}_{π} ) = \vert {ψ}_{\frac{1}{2}} ( 0 ) , while \vert {ψ}_{- \frac{1}{2}} ( {t}_{π} ) = \vert {m}_{S} = - 1 , {m}_{I} = - 1 / 2 .$$

This allows mapping the population of the nuclear spin 102 states |m_{I}=±½) to electronic spin 103 states |mₛ=0, −1), respectively. The electronic spin 103 population can then be read out through the NV fluorescence intensity

$${S}_{\pm \frac{1}{2}} ,$$

which measures the total population in electronic spin 103 state |mₛ=0 [symbol] irrespective of the nuclear spin 102 state, that is,

$${{S}_{\pm \frac{1}{2}} = \vert 〈 {m}_{S} = 0 , {m}_{I} = 1 / 2 \vert {ψ}_{\pm \frac{1}{2}} \vert}^{2} + \vert 〈 {m}_{S} = 0 , {m}_{I} = - 1 / 2 {\vert {ψ}_{\pm \frac{1}{2}} \vert}^{2} .$$

The NV fluorescence intensity

$${S}_{\pm \frac{1}{2}} ,$$

can be measured through application of laser pulse 605 during readout 612. For example, referring to system 100 shown in FIG. 1, laser 110 results in a florescence emission, correlated with NV fluorescence intensity

$${S}_{\pm \frac{1}{2}} ,$$

from the nuclear-electronic dual spin system 101 detectable using detector 114. Mapping fidelity (or contrast) can be defined as

$$= {S}_{\frac{1}{2}} - {S}_{- \frac{1}{2}} ,$$

which is then used to calculate the sensitivity improvement factor α₀(Ω, B) [symbol] (Ω, B) (discussed above in relation to heat maps 430a and 430b of FIG. 4C) where α₀ is the rotation rate enhancement 209 factor due to the hyperfine interaction.

FIG. 7B is a set of graphs 720a, 720b showing the evolution dynamics of the NV spin under normal and adaptive Rabi drives and a magnetic field of B=800 G. A 1 MHz Rabi drive was analyzed at two different rotation rates, graph 720a shows the results for a rotation rate 112 of 1 kHz and graph 720b shows the results for a rotation rate 112 of 10 kHz. The system 101 is initialized at t=0 to mₛ=0, m_{I}=½ state with an aligned magnetic field B=800 G. The driving frequency is either set to the initial transition frequency of electronic spin 103 for m_{I}=½ nuclear spin state (normal control, solid curves) or set to follow the transition frequency (adaptive control, dashed curves) adaptively. Under normal control, data for electronic spin 103 mₛ=0 is shown by solid curves 721 and electronic spin 103 mₛ=−1 is shown by solid curves 722. Under adaptive control and nuclear spin 102 mₛ=½, data for electronic spin 103 mₛ=0 is shown by dashed curves 723 and electronic spin 103 mₛ=−1 is shown by dashed curves 724. Under adaptive control and nuclear spin 102 mₛ=−½, data for electronic spin 103 mₛ=0 is shown by dashed curves 725 and electronic spin 103 mₛ=−1 is shown by dashed curves 726. As shown in FIG. 7B, even though the pulse fidelity worsens at a larger rotation rate as shown in graph 720b, such a challenge can be addressed by changing the driving frequency with an adaptive scheme.

Given the typical NV fluorescence readout, embodiments measure the nuclear spin 102 state by mapping it onto the population of NV electronic spin on mₛ=0 by applying a selective (CNOT) mapping pulse, for example microwave pulse 606. To quantitatively calculate the fidelity degradation effect, one can calculate for both cases (nuclear spin initial state m_{I}=½ (shown by dashed curves 723, 724) and m_{I}=−½ (shown by dashed curves 725, 726)) the system evolution under the selective microwave Rabi drives and obtain their maximum population difference on the mₛ=0 electronic spin state. When there is no system rotation during the application of the microwave drive, the achieved population difference is 1 and the mapping procedure is perfect. It would be known to one of skilled in the art that embodiments can utilize alternative methods for measuring nuclear spin 102 and electronic spin 103 states to determine their overlap and derive system's 101 rotation rate 112 Ω or rotation θ.

### Performance Near the GSLAC

In some embodiments, the enhancement factor α₀ reaches its

$$maximum value \approx \frac{{γ}_{e}}{\sqrt{2} {γ}_{n}} \approx 4 \times {10}^{3}$$

near the GSLAC condition when B ˜ D/Ye ˜ 1024 G, in that scenario the behavior of the gyroscope 100 becomes more complex. Due to its small energy gap, the electron spin 103 not only is strongly mixed with the nuclear spin 102 but it also no longer follows a completely adiabatic evolution. Nevertheless, simulation results indicate that even at large magnetic fields, the enhancement 209 of the nuclear spin 102 rotation compared to the electron spin 103 is maintained. The hyperfine interaction still yields a relative rotation between the two spins 102, 103, and the rotation rate Ω 112 can still be recovered.

### Gyroscope Sensitivity

### Hyperfine-Enhanced Gyroscope

The sensitivity of the embodiments of gyroscope 100 for an ensemble of N spins is given by

$$η = \frac{σ {e}^{t / τ} \sqrt{t + {t}_{d}}}{2 C \sqrt{N} \vert {\partial }_{Ω} S ( t ) \vert} \qquad ( 16 )$$

where t is the total sensing time, t_{d} is the deadtime, τ is the coherence time, C is the readout efficiency parameter that is typically set by the signal contrast and photon collection efficiency, N is the total number of spins, and S(t) and σ its standard deviation from the spin projection noise.

In practice, to optimize the sensitivity, embodiments can maximize the signal slope by measuring the nuclear spin 102 population along \hat{x}_{NV} (the x-axis in the NV frame of reference). This can be accomplished by applying a π/2-pulse, for example radiofrequency pulse 607 from source 113, to the nuclear spin 102 before readout 604 at the time of near-alignment condition, as shown in timeline 600 of FIG. 6, yielding the signal:

$${S}_{x} ( t ) = \frac{1}{2} ( 1 + \frac{{α}_{0} sin ( Ω t )}{\sqrt{{α}_{0}^{2} {sin}^{2} ( Ω t ) + {cos}^{2} ( Ω t )}} ) . \qquad ( 17 )$$

To ensure continuous operation of the protocol as well as efficient polarization and readout, it can be required that

$$t + {t}_{d} \approx ⌈ \frac{Ω t}{π} ⌉ ( \frac{π}{Ω} )$$

and assume the initialization and readout times (˜3 μs under large laser 110 power and fast control pulses 605, 606, 607) are small in comparison to period of the oscillation 2π/Ω. The sensitivity then gives

$$η ( Ω ≪ {γ}_{n} B , B , t ) = \qquad ( 18 )$$

$$\frac{1}{( \frac{{a}_{0}}{2} ) \vert \frac{cos ( Ω t )}{{( {α}_{0}^{2} {sin}^{2} ( Ω t ) + {{cos}^{2} ( Ω t )}^{2} )}^{3 / 2}} \vert} ( \frac{{e}^{t / τ} \sqrt{⌈ \frac{Ω t}{π} ⌉ ( \frac{π}{Ω} )}}{2 C \sqrt{N} t} ) \geq \frac{{e}^{t / τ}}{C \sqrt{N} {α}_{0} \sqrt{t}}$$

Hence the optimal sensitivity is achieved when the sensing time t≈kπ/2 and the sensitivity has an enhancement of α₀ in comparison to the conventional scheme based on nuclear Ramsey (where |∂_{Ω}S(t)|ₘₐₓ=t/2). The ultimate bound on the sensitivity occurs near GSLAC, where

$${α}_{0} \approx \frac{{γ}_{e}}{\sqrt{2} {γ}_{n}} ,$$

and with sensing time t≈τ/2.

Assuming a typical NV diamond system 101 comprising a chip of volume V=1 mm³ with N=2.5×10¹⁴ spin sensors, detection efficiency C˜2% and coherence time τ=1.51₁ₑ≈7.5 ms, the sensitivity bound (Eq. (18)) of embodiments can achieve η(Ω<<γₙB, B≈1024 G, t≈τ/2)≈1×10⁻³ (mdeg/s)/\sqrt{Hz}, comparable with atomic gyroscopes.

Nevertheless, for slow rotations such that the signal decay time is on the same order as the rotation period when τ=π/Ω, there is a tradeoff: the measurement needs to be made as quickly as possible after initialization of the electron spin to maintain the high sensitivity enhancement factor in the signal, which has a conflict with maximizing the sensing time. In this case, the sensitivity enhancement is dictated by the factor ∂ₜS(t). For even lower rates where Ωτ<<1, the sensing time is again limited by the coherence time and the deadtime, thus reaching the sensitivity bounds of the case whereτ>>π/Ω.

### Inertial Gyroscope

When sensing fast rotations Ω>>γₙB, the electron spin 103 and nuclear spin 102 still need to be nearly aligned with the magnetic field when reading out, so it is still required that

$$t + {t}_{d} \approx ⌈ \frac{Ω t}{π} ⌉ ( \frac{π}{Ω} )$$

and the sensitivity (measured along \hat{x}_{NV}) is given by

$$η ( Ω ≫ {γ}_{n} B , B , t ) = \frac{1}{( \frac{1}{2} ) \vert cos ( Ω t ) \vert} ( \frac{{e}^{t / τ} \sqrt{⌈ \frac{Ω t}{π} ⌉ ( \frac{π}{Ω} )}}{2 C \sqrt{N} t} ) \geq \frac{{e}^{t / τ}}{C \sqrt{N} \sqrt{t}} \qquad ( 19 )$$

The lower bound for the optimal sensitivity of the sensor can thus be approximated

$${η}_{opt} \approx \frac{\sqrt{2 e}}{C \sqrt{N τ}} \approx 4.91 ( mdeg / s ) / \sqrt{Hz} for τ \approx 7.5 ms .$$

### Comparison With Other Protocols

The most conventional prior art method in sensing a rotation using a spin-based gyroscope is the nuclear spin-based Ramsey protocol. The Ramsey protocol using the nuclear spin has a signal of the form

$$S ( t ) = \frac{1}{2} ( 1 + sin ( Ω t ) ) .$$

Thus, the sensitivity is similar to that given in Eq. 19:

$${η}_{N - Ramsey} ( t ) = \frac{1}{( \frac{1}{2} ) \vert cos ( Ω t ) \vert} ( \frac{{e}^{t / τ} \sqrt{t + {t}_{d}}}{2 C \sqrt{N} t} ) \qquad ( 20 )$$

and yields a lower bound to the sensitivity

$${η}_{opt} \approx \frac{\sqrt{2 e}}{c \sqrt{N τ}} .$$

The coherence time for the Ramsey sequence is limited by the spin dephasing time T₂ₙ^{*}≤1.5T₁ₑ. Thus, even in the fast rotation sensing regime (without hyperfine-enhancement) of embodiments of the gyroscope 100 disclosed herein in this work, the sensitivity is slightly improved compared to the conventional nuclear spin Ramsey scheme, as τ>1.5T₁ₑ in numerical simulations.

Alternatively, with the assistance of the external magnetic field along the inertial reference frame's \hat{z}-axis (like the gyroscope 100 shown in FIG. 1), the change in the electronic spin 103 transition frequency can also be used to extract the rotation rate (for a transverse rotation along ŷ). In this case, similar to conventional magnetometry, this is measured with a Ramsey experiment with the electronic spin 103, ultimately limited by the spin dephasing time τ=T₂ₑ^{*}<<T₁ₑ. The signal of the Ramsey is given by

$$S ( t ) = \frac{1}{2} ( 1 + sin ( {ω}_{e} t ) ) ,$$

where ωₑ=ωₑ(θ) is the rotation-angle dependent electronic spin 103 transition frequency. Thus, the sensitivity is given by

$${η}_{NV - Ramsey} ( t ) = \frac{1}{( \frac{1}{2} ) \vert cos ( {ω}_{e} t ) \frac{\partial {ω}_{e}}{\partial θ} \vert} ( \frac{{e}^{t / τ} \sqrt{t + {t}_{d}}}{2 c \sqrt{N} {t}^{2}} ) \qquad ( 21 )$$

In an electronic spin 103 ensemble, the spin dephasing time is typically 2 to 3 order-of-magnitude shorter than in a nuclear spin 102 ensemble, while the derivative

$$\frac{\partial {ω}_{e}}{\partial θ}$$

increases with an increase in the magnetic field and can improve the sensitivity. Thus, it is not straightforward to analytically compare the electron spin 103 scheme to nuclear spin 102 schemes ones. However, a few special conditions were explored, near GSLAC at B≈1000 G,

$${\vert \frac{\partial {ω}_{e}}{\partial θ} \vert}_{max} \approx ( 2 π ) 4 \times 1 {0}^{3} MHz / rad ,$$

and although T₂ₑ^{*}<<T₁ₑ, the sensitivity is improved compared to the prior spin nuclear-based Ramsey protocol, with η_{opt≈}0.2 (mdeg/s)/\sqrt{Hz} for T₂ₑ^{*}=0.7 μs but still worse than embodiments of the hyperfine-enhanced gyroscope 100. The results of a sensitivity comparison between nuclear spin-based Ramsey protocol 421, electronic spin-based Ramsey protocol 422, and embodiments of the hyperfine-enhanced gyroscope 423 are shown in graph 420 of FIG. 4B.

### Adiabatic Range for Hyperfine-Enhanced Sensing

The hyperfine-enhanced gyroscope protocol utilized by embodiments (for non-limiting example gyroscope 100 of FIG. 1A) requires that the nuclear spin 102 quantization axis follow the effective magnetic field (B_{eff}) axis adiabatically, as shown in FIGS. 1B and 2B. If the gyroscope 100 operates in regimes where the rotation rate is expected to be significantly less than the ZFS D=2π×2.87 GHz, the electronic spin 103 is expected to follow the eigenstate set by the crystalline axis (the NV axis, \hat{z}_{NV}) of the diamond which rotates with system 101 at rotation rate 112. Nevertheless, because the ¹⁵N atoms inside the NV center of system 101 do not have a large quadrupole term, the energy splitting of the nuclear spin 102 is dependent on the magnetic field 104 strength, and the rotation 112 has to be sufficiently slow with respect to γₙB such that the evolution of the nuclear spin 102 remains adiabatic and the hyperfine-enhanced signal can be measured.

The derivation of the adiabatic criteria for the nuclear spin can be found in the appendix material of Wang et al., Phys. Rev. Lett. 133, 150801 (2024), which is incorporated herein fully by reference. The nuclear spin 102 remains adiabatic when

$$ℳ ( t ) = \frac{{\vert 〈 {ψ}_{+} \vert \frac{\partial {ψ}_{-}}{\partial t} 〉 \vert}^{2}}{{E}_{+}^{2}} ≪ 1 \qquad ( 22 )$$

Thus, to maintain the adiabaticity of the nuclear spin 102 during the evolution, embodiments require [symbol] (t)<<1 during the rotation.

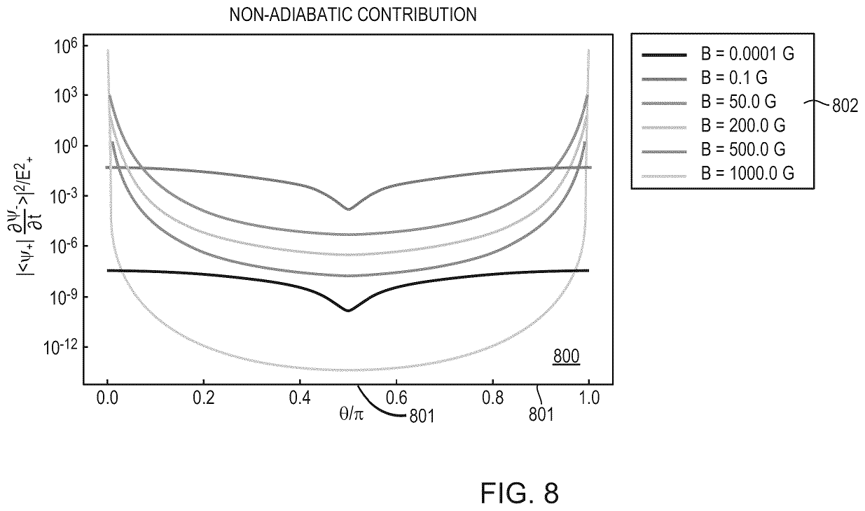

FIG. 8 is a graph 800 of the eigenstate deviation [symbol] (t) of example embodiments as a function of the rotation angle (at a fixed rotation rate (2π)0.1 kHz), for various values of magnetic field strength. Key 802 identifies the data displayed in graph 800 for a range of magnetic field strengths, 0.0001 G≤B≤1000.0 G. As B increases, [symbol] (t) is suppressed and the system becomes adiabatic and embodiments can perform sensing in the hyperfine-enhanced regime (as shown in FIG. 1B and schematic 211 of FIG. 2B). As B decreases, [symbol] (t) increases, and the system is in the intermediate regime where a rotation signal is difficult to extract due to the non-adiabatic evolution of the nuclear spin. Nevertheless, for a sufficiently small B, [symbol] (t) begins to decrease again and embodiments of gyroscope 100 can sense in the inertial regime where the nuclear spin 102 is fixed in its initial eigenstate during the rotation (as shown in FIG. 1C and schematic 221 of FIG. 2B).

By numerically computing [symbol] (t) for different values of B over the course of θ=Ωt ∈ [0, π] for a chosen Ω=0.1 kHz, it is shown that [symbol] (t) reaches its minimum value at point 801, θ=π/2, where the effective magnetic field is the largest. Calculating [symbol] (t) at a time t=t₀ allows definition of a cutoff e such that the system 101 is sufficiently adiabatic to achieve a measurable signal of the rotation. E is defined as the maximal acceptable signal uncertainty (ΔS), which then sets a standard to quantify the projected range of frequencies detectable by the hyperfine-enhanced gyroscope 100 for a desired precision.

At the minimum point 801, θ=π/2, one can simplify [symbol] (t) from Eq. 22

$${ℳ}_{min} = \frac{4 {( \frac{Ω}{B {γ}_{n}} )}^{2}}{{( {α}_{0}^{2} + {( \frac{Ω}{B {γ}_{n}} )}^{2} )}^{2}} \qquad ( 23 )$$

If embodiments of the gyroscope 100 require that the adiabatic condition for the nuclear spin satisfy [symbol] ₘᵢₙ<ξ² for some ξ, and assume that

$$\frac{Ω}{B {γ}_{n}} ≪ 1 ,$$

to first order, the rotation rate 122 can be approximated:

$$Ω < {ξα}_{0}^{2} B {γ}_{n} \qquad ( 24 )$$

Thus, the maximum detectable rotation rate by embodiments of the hyperfine-enhanced gyroscope 100 is given by Ωₘₐₓ∝α₀²B. Thus, the enhancement factor also suppresses the non-adiabatic contribution of the rotation on the nuclear spin 102, so for large magnetic fields, the range for detectable rotation rates is significantly enhanced.

For fast rotations, Applicants require the nuclear spin 102 to remain in its initial eigenstate and be decoupled from the electronic spin 103 and system 101 rotation. In this regime, as Ω>>γₑB, the effective nuclear Hamiltonian becomes time-independent H(t) ≈−ΩI_{y}, and [symbol] (t)<<1, a similar analysis can be used to characterize a minimum rotation rate for fast-rotation sensing Ωₘᵢₙ.

### Simulation Details

To simulate the dynamics of the system one can either work in the lab or inertial frame of reference where the diamond (system 101), and thus the zero-field splitting and hyperfine interaction tensors, rotate; or work in the diamond (NV) frame of reference, where the system 101 sees a rotating external magnetic field, as well as an effective field along the rotation axis due to the non-inertial frame. Details regarding the simulations performed to obtain the data disclosed herein can be found in the appendix material of Wang et al., Phys. Rev. Lett. 133, 150801 (2024), which is incorporated herein fully by reference. It would be known to one of skilled in the art that many applicable simulation method or parameters could also be used to obtain similar results and quantify the properties and dynamics of embodiments of gyroscope 100 and its components including system 101, the nuclear spin 102, electronic spin 103, spin interactions/overlap, applied pulses 605, 606, 607, and outputted signals and readouts 608.

While example embodiments have been particularly shown and described, it will be understood by those skilled in the art that various changes in form and details may be made therein without departing from the scope of the embodiments encompassed by the appended claims.

What is claimed is:

1. A gyroscope comprising:
a diamond structure with a nitrogen-vacancy (NV), the nitrogen-vacancy (NV) containing a nitrogen atom;
wherein the nitrogen-vacancy (NV) has an electronic spin along a first axis ( [symbol] _{NV}) and the nitrogen atom has a nuclear spin along a second axis;
wherein the first axis ( [symbol] _{NV}) is correlated with an orientation of the diamond structure and the second axis is decoupled from the orientation of the diamond structure; and
wherein the rotation rate of the orientation of the diamond structure (Ω) can be determined based on a projection of the nuclear spin onto the first axis.

2. The gyroscope of claim 1 further comprising a photodetector configured to detect a fluorescence signal produced by the nitrogen-vacancy (NV) interacting with a laser, the detected fluorescence signal correlated with a state of the electric spin along the first axis ( [symbol] _{NV}).

3. The gyroscope of claim 1 further comprising a CNOT gate configured to map the state of the electric spin along the first axis ( [symbol] _{NV}) with a state of the nuclear spin to enable determining the projection of the nuclear spin onto the first axis ( [symbol] _{NV}) based upon the state of the electric spin along the first axis ( [symbol] _{NV}).

4. The gyroscope of claim 1 wherein the nitrogen atom is a ¹⁵N atom.

5. The gyroscope of claim 1 wherein the rotation rate of the orientation of the diamond structure is about a third axis (ŷ) distinct from the first axis ( [symbol] _{NV}).

6. The gyroscope of claim 1 wherein the electronic spin is quantized along the first axis ( [symbol] _{NV}) and the first axis adiabatically follows the orientation of the diamond structure.

7. The gyroscope of claim 1 further comprising:
a source configured to apply an external magnetic field to the diamond structure, the applied external magnetic field causing the second axis to become correlated with a direction of the applied external magnetic field (B).

8. The gyroscope of claim 7 wherein the rotation rate of the orientation of the diamond structure (Ω) is significant less than a Larmor frequency of the nuclear spin.

9. The gyroscope of claim 7 wherein hyperfine coupling between the electronic spin and the nuclear spin enhances the rotation of the nuclear spin with respect to the first axis ( [symbol] _{NV}).

10. The gyroscope of claim 9 wherein the applied magnetic field has a magnitude configured to approximate the GSLAC condition (γₑB≈D) and maximize the enhancement of an angular difference between the first axis ( [symbol] _{NV}) and the second axis.

11. A method of determining rotation rate, the method comprising:
rotating, at a rotation rate, a diamond structure with a nitrogen-vacancy (NV), the nitrogen-vacancy (NV) containing a nitrogen atom;
wherein the nitrogen-vacancy (NV) has an electronic spin along a first axis ( [symbol] _{NV}) and the nitrogen atom has a nuclear spin along a second axis;
wherein the first axis ( [symbol] _{NV}) is correlated with an orientation of the diamond structure and the second axis is decoupled from the orientation of the diamond structure; and
determining the rotation rate based on a projection of the nuclear spin onto the first axis.

12. The method of claim 11 further comprising detecting a fluorescence signal produced by the nitrogen-vacancy (NV) interacting with a laser, the detected fluorescence signal correlated with a state of the electric spin along the first axis ( [symbol] _{NV}).

13. The method of claim 1 further comprising mapping the state of the electric spin along the first axis ( [symbol] _{NV}) with a state of the nuclear spin to enable determining the projection of the nuclear spin onto the first axis ( [symbol] _{NV}) based upon the state of the electric spin along the first axis ( [symbol] _{NV}).

14. The method of claim 11 wherein the nitrogen atom is a ¹⁵N atom.

15. The method of claim 11 wherein the rotation rate of the orientation of the diamond structure is about a third axis (ŷ) distinct from the first axis ( [symbol] _{NV}).

16. The method of claim 11 wherein the wherein the electronic spin is quantized along the first axis ( [symbol] _{NV}) and the first axis adiabatically follows the orientation of the diamond structure.

17. The method of claim 11 further comprising applying an external magnetic field to the diamond structure, the applied external magnetic field causing the second axis to become correlated with a direction of the applied external magnetic field (B).

18. The method of claim 17 wherein the rotation rate (Ω) is significant less than a Larmor frequency of the nuclear spin.

19. The method of claim 17 wherein hyperfine coupling between the electronic spin and the nuclear spin enhances the rotation of the nuclear spin with respect to the first axis ( [symbol] _{NV}).

20. The method of claim 19 wherein the applied magnetic field has a magnitude configured to approximate the GSLAC condition (γₑB≈D) and maximize the enhancement of an angular difference between the first axis ( [symbol] _{NV}) and the second axis.
